(19) United States
(12) Patent Application Publication
(10) Pub. No.: US 2009/0130887 A1
(43) Pub. Date: May 21, 2009

(54) LOCKING DEVICE FOR A RAPID UNCOUPLING CONNECTION ASSEMBLY AND CONNECTORS EQUIPPED WITH SUCH A DEVICE

(75) Inventors: Sebastien Guilbert, Thiais (FR); Eric Marmet, Choisy en Brie (FR); Bruno Viairon, Nogent sur Marne (FR); Jean-Yves Maladry, Sartrouville (FR)

Correspondence Address: PERMAN & GREEN, 425 POST ROAD, FAIRFIELD, CT, 06824, US

(73) Assignee: SOURIAU, Versailles (FR)

(21) Appl. No.: 12/269,277

(22) Filed: Nov. 12, 2008

(30) Foreign Application Priority Data
Nov. 21, 2007 (FR) 0708157

(51) Int. Cl. H01R 13/62

(52) U.S. Cl. 439/321

(57) ABSTRACT

A locking device for a rapid uncoupling connection assembly including a fixed part consisting of a receptacle), a releasable part able to become separated from the receptacle consisting of a plug equipped with a locking and unlocking device of the connection assembly in which latter the connector corresponding to the releasable part includes two interior and exterior concentric rings, the interior ring carrying erasable means of coupling actuated so as to be able to occupy two functional positions, namely a blocking position and an unblocking position, the exterior ring including means of blocking and unblocking of the two functional positions, in which the interior ring is a claw socket consisting of a ferrule provided with sectors defining the cantilever beams, the socket being arranged between the receptacle of the fixed part and the exterior ring of the releasable part.

### BACKGROUND

1. Field

The disclosed embodiments are directed to a locking device for a rapid uncoupling connection assembly. The disclosed embodiments are also directed to providing electrical connectors equipped with such a device.

2. Brief Description of Related Developments

The disclosed embodiments have a particular application in connection assemblies of the releasable type, also called lanyard disconnect connector, consisting either of rotation or of longitudinal push coupling type circular electrical connectors, or of rectangular-type polygonal electrical connectors, for example of the longitudinal push coupling type.

More precisely, the disclosed embodiments relate to electrical connection assemblies of the type of those comprising a first connector constituting the so-called fixed part of an electrical connection assembly, generally positioned on the wall of a machine and a second connector constituting the so-called releasable part, which is able to become separated from the fixed part under the action of a traction effort.

Electrical connection assemblies of this type are well known. In these assemblies the fixed part generally comprises a receptacle, an insulating block able to move inside the receptacle and located in the direction of the insertion of the releasable part in the receptacle of the fixed part, connection elements held in the insulating block and providing electrical continuity between conductors respectively connected to the fixed and releasable parts, when the releasable part is locked on the fixed part, the said electrical continuity being automatically broken when the fixed and releasable parts become separated.

These connection assemblies concern more particularly machines of the rocket or missile type and provide, for example before a rocket is launched, an electrical connection between the conductors located inside the rocket and the conductors of exterior cables connected to measurement, control and transmission of command signals apparatus.

In these connection assemblies it is important to control, on the one hand, the easy insertion and locking of the two connectors of the assembly and on the other hand, to ensure during the application of traction to one of the connectors, the efficient and rapid uncoupling of the connection assembly.

It is thus that patent FR 2 587 143 describes a coupling, mechanical locking and unlocking device of a connection assembly, in which the connector which corresponds to the releasable part, comprises two concentric rings, the interior ring carrying erasable means of coupling actuated so as to be able to occupy two functional positions, namely a blocking position and an unblocking position of the two rings. Locking is provided by a deformable rod, which prevents any untimely return of the exterior ring, when it does not receive an appropriate axial effort greater than the elastic deformation effort on the deformable rod.

Patent FR 1 188 558 describes a rapid uncoupling connection device consisting of a central rod with a variable exterior diameter, a cylindrical ring arranged coaxially round the rod, movable elastic fingers furnished with widened ends, which are slightly flexible in a radial direction and arranged in annular manner round the central rod and inside the cylindrical ring and supported by a jacket linked to the body of the releasable connector. Locking takes place by radial extension of the widened ends of the fingers on the annular surfaces of the rod and by the blocking of these fingers with the help of the cylindrical ring. Unlocking takes place by the release of the central rod and the erasure of the elastic fingers.

U.S. Pat. No. 3,885,851 describes the use of a split plastic ring equipped with cantilever fingers on which a retaining spring and a retaining ring act jointly as a rapid uncoupling device.

The embodiments of the prior art nevertheless have drawbacks, since they contain a large number of individual parts positioned one by one, which complicates the assembly of the connectors and which may most importantly compromise, by jamming, the functioning of the connection assembly during the process of separation of the fixed and the releasable parts.

In fact, these individual parts occur in the form of balls, fingers or tiles, springs, rings and due to their mobility can act, depending on the direction of the extraction effort applied, on the axis of the part to be disconnected which may, on the start of the disconnection operation, become tilted at an angle with respect to the axis of the fixed part and so cause a delay of the function of release.

### SUMMARY

The disclosed embodiments address the drawbacks of the prior embodiments and provide a locking device for rapid uncoupling connection assemblies consisting of a fixed part comprising a receptacle, a releasable part able to become separated from the receptacle consisting of a plug equipped with a locking and unlocking device of the connection assembly, in which latter the connector corresponding to the releasable part comprises two concentric rings, the interior ring carrying erasable means of coupling actuated so as to be able to occupy two functional positions, namely, a blocking position and an unblocking position, the exterior ring carrying a means of blocking and unblocking of the two functional positions, a device in which the interior ring is a ferrule provided with sectors defining cantilever beams arranged between the receptacle of the fixed part and the exterior ring of the releasable part.

According to a first characteristic of the disclosed embodiments, the beams comprise on their internal surface a thread making possible their coupling with a thread of the receptacle.

According to a second characteristic of the disclosed embodiments, the beams comprise on their internal surface a dimple making possible their coupling with a dimple of the receptacle.

According to a principal characteristic of the disclosed embodiments, each cantilever beam has a section, which is non-uniform over its entire length and has maximum elasticity in return for minimum effort in the elastic domain of the material.

According to another characteristic of the disclosed embodiments, the material of the ferrule is an aluminium alloy.

According to a first mode of embodiment, a rotational coupling circular electrical connector comprises a rapid uncoupling locking device consisting of two concentric rings, the interior ring carrying erasable means of coupling actuated so as to be able to occupy two functional positions, namely, a blocking position and an unblocking position, the interior ring being a ferrule provided with sectors defining the cantilever beams.

According to a second mode of embodiment, a longitudinal push coupling circular electrical connector comprises a rapid uncoupling locking device consisting of two concentric rings, the interior ring carrying erasable means of coupling actuated so as to be able to occupy two functional positions, namely, a blocking position and an unblocking position, the interior ring being a ferrule provided with sectors defining the cantilever beams.

According to a third mode of embodiment, a longitudinal push coupling polygonal electrical connector comprises a rapid uncoupling locking device consisting of two concentric elements, the interior element carrying erasable means of coupling actuated so as to be able to occupy two functional positions, namely a blocking position and an unblocking position, the interior element being a ferrule provided with sectors defining the cantilever beams.

The disclosed embodiments will be better understood from the following description and the appended figures where

### BRIEF DESCRIPTION OF THE DRAWINGS

FIGS. 1a and 1b are sections of a connection assembly of the prior art;

FIG. 2 shows a first mode of embodiment of the locking device;

FIG. 3 shows a second mode of embodiment of the locking device;

FIG. 4 is a 4-4 section of FIG. 3,

FIG. 5 is a section of a connection assembly according to the first embodiment;

FIGS. 6a to 6d are sections of the sequences of release of a connector according to the first mode of embodiment;

FIGS. 7a to 7d are sections of the sequences of coupling of the connectors of a connection assembly according to the second mode of embodiment.

### DETAILED DESCRIPTION OF THE DRAWINGS

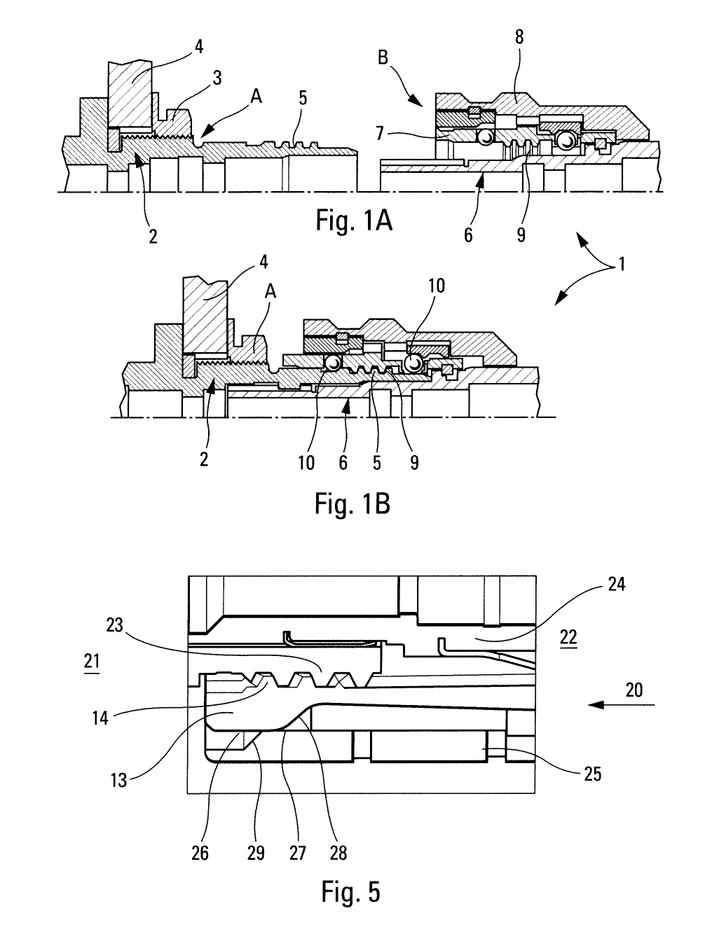

FIG. 1 shows a connection assembly according to the prior art, in which a first connector A or receptacle constitutes the fixed part of the assembly of connection 1, whilst a second connector B or plug constitutes the so-called releasable part of the connection assembly.

In all the figures in the present description, only the housings of the connectors and their respective devices, which participate in locking, are shown. Clearly, these housings are equipped with insulators, which are in turn equipped with connection elements such as electrical or optical contacts. To ensure clarity of the figures, the insulators and contacts are not shown.

According to FIG. 1A, the receptacle A comprises a hollow tubular housing 2 provided at one end with means of fixing 3, in order to retain it in an orifice of the wall 4. In a known fashion, housing 2 comprises a thread 5 at its other end, namely the end by which it is coupled to the plug B.

The plug B, which constitutes the terminal of a cable (not shown) comprises a hollow housing 6, one of whose ends is destined to be coupled with receptacle A by engaging inside the housing 2 and comprises on its exterior face a means of coupling and of blocking, consisting principally of an interior ring 7 and an exterior ring 8.

The interior ring 7 is provided with a thread 9 and during the coupling of receptacle A and plug B, their gradual approach takes place due to tightening consequent on the rotation of the exterior and interior rings and the engagement of the threads 5 and 9.

FIG. 1B shows the connection assembly coupled and locked by means of balls 10 carried by the interior ring 7 and blocked by the means arranged on the exterior ring 8

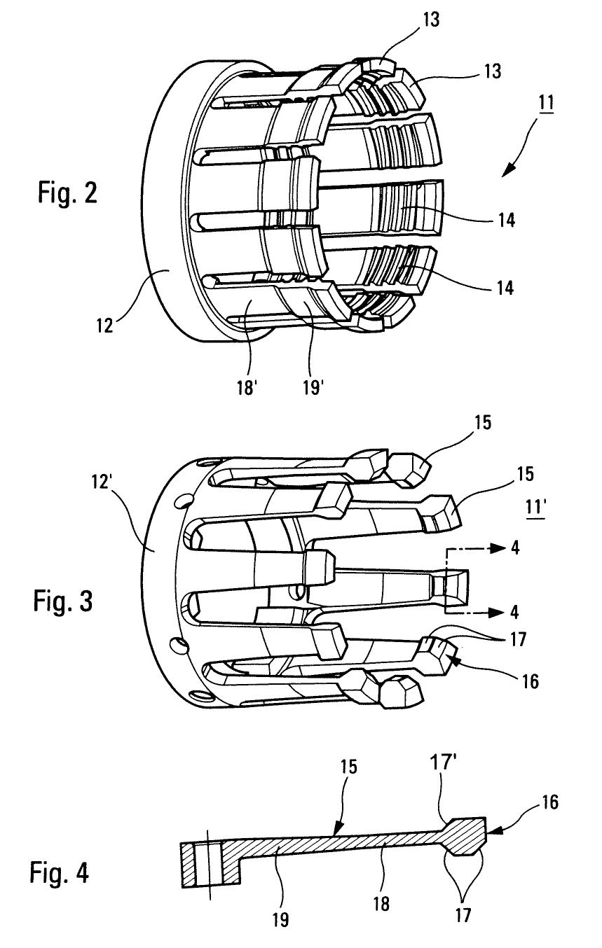

FIG. 2 shows a first mode of embodiment, comprising a so-called claw socket, the principal aspect of the disclosed embodiments. This socket consists of an aluminium alloy ferrule 11 protected by a layer of chemical nickel machined to define a low flange 12, whose section corresponds to the initial thickness of the ferrule and an assembly of sectors defining the beams 13 also called claws. Each beam 13 has a non-uniform section, that is to say, a section, which varies by zones over its entire length, to define an iso constrained or iso-stressed beam. The internal surface of the free end of the beams 13 comprises a thread 14, whose purpose will be described below and which corresponds to thread 9 in FIG. 1.

FIG. 3 shows a second mode of embodiment of the claw socket, in which the ferrule 11′ has a low flange 12′ and an assembly of beams 15 also called claws. Each beam 15 has a section which varies by zones over its entire length to define an iso constrained claw. The free end of the beams 15 defines a dimple 16, whose section corresponds to the initial thickness of the ferrule 11′ and which comprises a section with chamfers 17 on the interior surface of the beam 15 and a chamfer 17′ on the exterior surface of the beam 15. The purpose of this section will be described below.

FIG. 4 is a section along axis 4-4 of FIG. 3 and shows a beam 15 with a non-uniform section consisting of two zones 18, 19 of different sections obtained during the machining of the ferrule 11′. Zone 18 is completely rectilinear and participates in the deflection of the beam 15, whilst zone 19 has a tapered section, which constitutes a variable inertia element of the elastic beam 15, which accordingly works in deflection in quasi iso-constraint and hence distributes the load over the entire length of the beam.

The position is the same in the case of beams 13, whose zones 18′ and 19′ have maximum elasticity for minimum effort, whilst remaining in the elastic domain of the aluminium alloy.

In fact, the use of a segment generating a variation of inertia in a part of a beam of the elastic claw socket according to the disclosed embodiments, makes it possible to improve to a remarkable extent the structural characteristics of the locking sockets, making possible an insertion and an ejection of average force during the coupling and uncoupling of the receptacles and the plugs of the connection assemblies, whilst retaining the intrinsic properties of mechanical retention.

FIG. 5 represents a first mode of embodiment of a rapid uncoupling connection assembly 20. This figure, although it is only a partial one, shows the principal elements of the disclosed embodiments, namely, the device making possible the locking on the receptacle 21 of the plug 22 and the rapid uncoupling, which makes possible the release of the plug 22.

The hollow tubular housing of the receptacle 21 comprises a threaded end 23, which penetrates into the means of coupling and of blocking arranged on the exterior surface of the body 24 of the plug 22. These means of coupling and of blocking principally comprise an interior claw socket represented by a beam 13 of the ferrule 11 and an exterior locking ring 25.

The beam 13 is provided with the thread 14 as previously explained and during the coupling of the receptacle 21 and of the plug 22, their gradual approach results due to the tightening effected by the rotation of the exterior ring 25 of the plug entraining by rotation the ferrule 11 and thus engaging the threads 14 and 23.

The locking of the connection assembly 20 is then provided by a spring located between the ferrule 11 and the locking ring 25, although in this configuration any transfer of the body of the plug is impossible, because the exterior surface 26 of the end of the beam 13 rests on the interior surface 27 of the exterior locking ring 25.

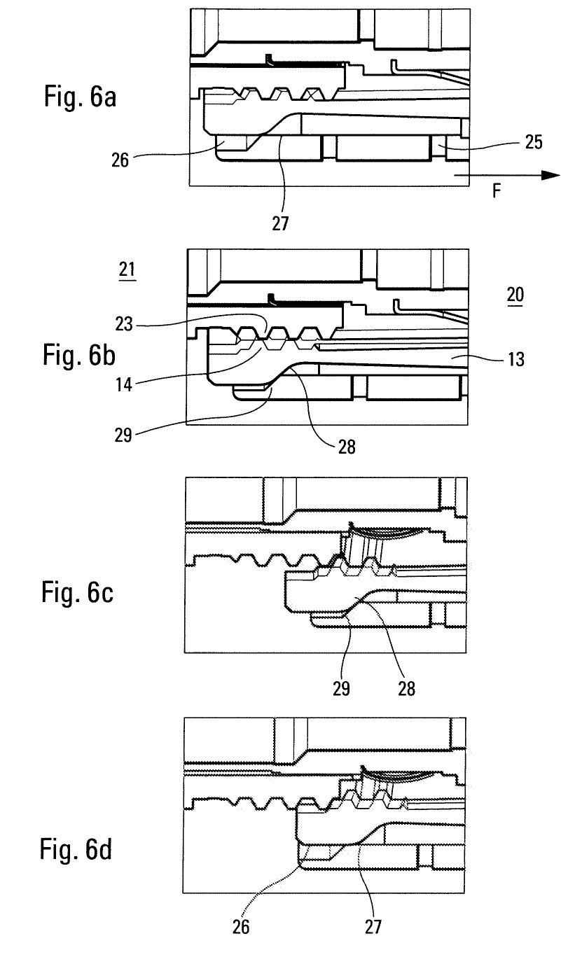

The end of the beam 13 has a chamfered end 28 whose task in concert with the chamfered end 29 of the ring 25 will appear in the phases of release of the plug 22 as described in FIGS. 6a to 6d.

FIG. 6a shows the first stage of release of the plug 22 due to the axial effort exerted by a rope (not shown) on the exterior blocking ring 25, which moves to the back of the plug as shown by the arrow F, thus unblocking the surfaces 26 and 27 of the beam and of the ring respectively.

FIG. 6b shows the thread 14 of the beam 13 disengaged from the thread 23 of the housing of the receptacle 21, thus enabling the plug 22 to travel in transfer to the outside of the receptacle 21 and to ensure through its release, the separation of the connectors of the connection assembly 20. During this stage the beam 13 becomes deformed under the combined action of the effort of traction exerted on the plug 22 as shown by the arrow F and of the section of the complementary threads 23 and 14.

FIG. 6b shows that when the plug has become separated from the receptacle, the beam 13 resumes its initial form, since no effort is being applied to the claw socket.

Finally, FIG. 6c shows the beam 13 resuming its initial form due to the concerted sliding action of the surfaces of the chamfered ends 28 and 29 of the exterior blocking ring 25 and of the beam 13. This stage accordingly leads to the final stage shown in FIG. 6d, in which the reciprocal surfaces 26 and 27 of the beam and of the ring 25 are again in contact, namely, in the position of protection of the elements of the locking device of the plug.

This first mode of embodiment, in which the locking devices offer absolute security of retention of the components, namely, a single claw socket, consisting of beams in iso-constraint connected by a flange, is preferentially applied to connection assemblies comprising a plug connector screwed onto a fixed connector or receptacle, whose uncoupling is implemented either by the release of the plug according to a movement in transfer, or by conventional unscrewing.

It sometimes happens that during the process of release of the plug 22, the exterior blocking ring 25 encounters obstacles and may therefore sustain deformation, rendering impossible any new utilisation of the plug equipped with exterior cables.

An additional advantage of the disclosed embodiments resides in the fact that the use of a limited number of parts makes possible the replacement of the exterior ring 25 and possibly of the ferrule 11, if the latter elements sustained damage.

According to the prior technique, in the case of an incident of this type, it was necessary to replace the associated plugs and cables completely.

According to the disclosed embodiments, the replacement of this expensive assembly is no longer necessary, because due to simple maintenance tooling, it is possible to keep the assembly consisting of the plug body 24 and the associated exterior cables sound, by extracting it from the damaged ring 25 and then reinserting it into a new exterior ring 25 equipped with its ferrule 11.

The stage of replacement of an equipped exterior ring 25 is carried out:

by screwing a maintenance tool into the plug 22, thus making possible deformation to free the body of the plug 24 of a retaining ring fastening the assembly of the ring 25 and the ferrule 11 onto the body of the plug 24,

by extracting the body of the plug 24,

by unscrewing the maintenance tool,

by inserting the body of the plug 24 into a new exterior ring 25, the retaining ring then becoming deformed to capture the assembly of the exterior ring 25 and the ferrule 11.

It should be noted that such a replacement without a new cabling operation of exterior cables on the contacts arranged in the insulation of the plug, makes rapid and cheap operations possible.

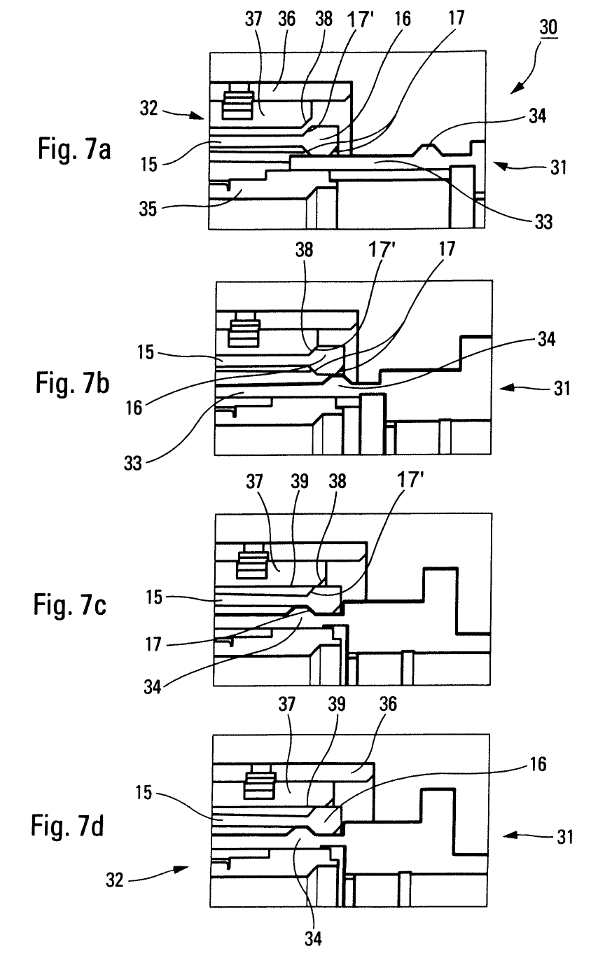

FIGS. 7a to 7d show a second mode of embodiment for connection assemblies using non-screwed connectors of the push-pull type (by longitudinal push) in which the receptacle and plug connectors are coupled according to a longitudinal transfer movement and uncoupled by a transfer movement in the opposite direction.

As in the preceding mode of embodiment, the locking devices afford absolute security of retention of the components, namely, a single claw socket consisting of the beams 15 in iso-constraint connected to a flange 12′.

This embodiment using circular connectors consists of circular elements like those in the first mode of embodiment. In the case of polygonal connectors of the rectangular type, it is understood that elements such as claw sockets have polygonal sections able to adjust themselves to complementary sections of exterior housings constituting blocking elements.

In this example, FIGS. 7a to 7d show the stages of coupling and of blocking of the fixed connector or receptacle 31 and of the releasable connector or plug 32 of the connection assembly 30. It is clear that the operations of uncoupling and unblocking are implemented by operations which are the reverse of those described below.

FIG. 7a shows a rapid uncoupling connection assembly 30. This figure, although it is only a partial one, shows the principal elements of the disclosed embodiments, namely, the device making possible the locking onto the receptacle 31 of the plug 32 and rapid uncoupling, making possible the release of the plug 32.

The hollow tubular housing of the receptacle 31 comprises an end 33 possessing on its exterior surface a chamfered dimple 34 penetrating into the means of coupling and of blocking arranged on the exterior surface of the body of the plug 35. These means of coupling and of blocking principally comprise an interior claw socket represented by a beam 15 of the ferrule 11′ and an exterior blocking ring 36 with a counter-ring 37 whose front end comprises a chamfer 38.

The beam 15 is equipped with a dimple 16 with chamfers 17 on the interior surface of the beam 15 and a chamfer 17′ on the exterior surface of the beam 15.

FIG. 7a shows the different components of the connection assembly during the initial stage of coupling, namely, the positioning and the orientation of the plug 32 with respect to the receptacle 31.

FIG. 7b shows the stage of introduction of the plug 32 into the receptacle with the sliding of the dimple 16 of the beam 15 on the exterior surface of the end 33 of the housing of the receptacle 31 as far as the dimple 34 of the said end. The push exerted on the plug 32 deforms the beam 15 by the sliding of the surface of the front chamfer 17 acting on the chamfered surface of the dimple 34. The deformation of the beam 15 brings it about that the chamfer 17′ of the dimple 16 comes into contact with the chamfer 38 of the counter-ring 37 of the blocking ring.

FIG. 7c shows the beam 15 in position of rest, ensuring by the participation of its back chamfer 17 and of the chamfer section of the dimple 34, the blocking of the plug 32 in the receptacle 31.

This blocking is now complete, as can be seen in FIG. 7d, by the push exerted on the exterior blocking ring 36, thus causing the internal surface 39 of the counter-ring 37 to block the dimple 16 of the beam 15.

The disclosed embodiments are not limited to the modes of embodiment described, but on the contrary comprises all variants.

1. A locking device for a rapid uncoupling connection assembly comprising a fixed part consisting of a receptacle, a releasable part able to become separated from the receptacle consisting of a plug equipped with a locking and unlocking device of the connection assembly in which latter the connector corresponding to the releasable part comprises two interior and exterior concentric rings, the interior ring carrying erasable means of coupling actuated so as to be able to occupy two functional positions, namely a blocking position and an unblocking position, the exterior ring comprising means of blocking and unblocking of the two functional positions, a device wherein the interior ring is a claw socket consisting of a ferrule provided with sectors defining the cantilever beams, the said socket being arranged between the receptacle of the fixed part and the exterior ring of the releasable part.

2. A locking device for a rapid uncoupling of a connection assembly according to claim 1, wherein the beams comprise on their internal surface a thread making possible their coupling via a thread to the receptacle.

3. A locking device for a rapid uncoupling connection assembly according to claim 1, wherein the beams comprise on their internal surface a dimple, making possible their coupling with a dimple of the receptacle.

4. A locking device for a rapid uncoupling connection assembly according to claim 1, wherein each cantilever beam has a non-uniform section over its entire length, so as to define a beam in iso-constraint.

5. A locking device for a rapid uncoupling connection assembly according to claim 4, wherein each cantilever beam has a maximum elasticity for a minimum effort in the elastic domain of the material.

6. A locking device for a rapid uncoupling connection assembly according to claim 1, wherein the material of the ferrule is an aluminium alloy.

7. A locking device for a rapid uncoupling connection assembly according to claim 6, wherein the surface of the aluminium alloy is protected by a layer of chemical nickel.

8. A locking device for a rapid uncoupling connection assembly according to claim 1, wherein the exterior ring and the ferrule are captured in the plug by means of a retaining ring located on the body of the plug.

9. A circular rotational coupling electrical connector having a locking device for a rapid uncoupling connection assembly comprising a fixed part consisting of a receptacle a releasable part able to become separated from the receptacle consisting of a plug equipped with a locking and unlocking device of the connection assembly, in which the connector corresponding to the releasable part comprises two concentric interior and exterior rings, the interior ring carrying erasable means of coupling actuated so as to be able to occupy two functional positions, namely, a blocking position and an unblocking position, the exterior ring comprising means of blocking and unlocking of the two functional positions, in which the interior ring is a claw socket consisting of a ferrule provided with sectors defining the cantilever beams, the said beam being arranged between the receptacle of the fixed part and the exterior ring of the releasable part.

10. A circular longitudinal push coupling electrical connector, having a rapid uncoupling connection assembly locking device comprising a fixed part consisting of a receptacle, a releasable part able to become separated from the receptacle consisting of a plug equipped with a locking and unlocking device of the connection assembly in which latter the connector corresponding to the releasable part comprises two concentric interior and exterior rings, the interior ring carrying erasable means of coupling actuated so as to be able to occupy two functional positions, namely, a blocking position and an unblocking position, the exterior ring comprising means of locking and unlocking of the two functional positions in which the interior ring is a claw socket consisting of a ferrule provided with sectors defining the cantilever beams, the said beam being arranged between the receptacle of the fixed part and the exterior ring of the releasable part.

11. A polygonal longitudinal push electrical connector having a locking device for rapid uncoupling connection assembly comprising a fixed part consisting of a receptacle, a releasable part able to become separated from the receptacle consisting of a plug equipped with a locking and unlocking device of the connection assembly in which the connector corresponding to the releasable part comprises two concentric interior and exterior rings, the interior ring carrying erasable means of coupling actuated so as to be able to occupy two functional positions, namely a blocking position and an unblocking position, the exterior ring comprising means of blocking and unblocking of the two functional positions in which the interior ring is a claw socket consisting of a ferrule provided with sectors defining the cantilever beams, the said beam being arranged between the receptacle of the fixed part and the exterior ring of the releasable part.
